(19) United States
(12) Patent Application Publication
(10) Pub. No.: US 2008/0039564 A1
(43) Pub. Date: Feb. 14, 2008

(54) AQUEOUS SOUND DAMPENING COATING COMPOSITION

(76) Inventors: Umesh C. Desai, Wexford, PA (US); Tien-Chieh Chao, Mars, PA (US); Anthony C. Palermo, Gibsonia, PA (US)

Correspondence Address: PPG INDUSTRIES INC;INTELLECTUAL PROPERTY DEPT, ONE PPG PLACE, PITTSBURGH, PA, 15272, US

(21) Appl. No.: 11/463,973

(22) Filed: Aug. 11, 2006

(51) Int. Cl. C08K 5/05

(52) U.S. Cl. 524/386; 524/423; 524/445

(57) ABSTRACT

An aqueous coating composition exhibiting sound dampening properties is disclosed. The coating composition comprises an aqueous dispersion of polymeric microparticles, a filler and at least two different plasticizers.

### FIELD OF THE INVENTION

The present invention relates to aqueous coating compositions with sound dampening properties.

### BACKGROUND OF THE INVENTION

Sound dampening coating compositions are applied to automotive floor pans, deck lids and doors of automobiles to dampen or reduce road and engine noise and vibrations For environmental reasons, aqueous coating compositions have been developed for such applications. However, since water is released from the coating composition upon drying or curing, the coating may shrink and may result in rough, uneven and cracked surfaces. Adjusting the filler content to improve appearance may adversely affect sound dampening properties and/or adhesion of the coating composition to the substrate. Plasticizers may improve appearance, but performance in this regard is not consistent. Thus, there is a need in the art for an aqueous coating composition that exhibits sound dampening properties and good appearance.

### SUMMARY OF THE INVENTION

The present invention is directed to an aqueous coating composition exhibiting sound dampening properties. The coating composition comprises an aqueous dispersion of polymeric microparticles, a filler and a plasticizer. The plasticizer comprises at least two different plasticizers and the plasticizer is present in the coating composition in an amount of from 0.1 to less than 20 percent by weight based on total weight of the coating composition. In an embodiment of the present invention, the filler may include barium sulfate and/or calcium metasilicate. In other embodiments, the sound dampening properties exhibited by the aqueous coating composition are measured by a composite loss factor of at least 0.01, or 0.1, at a frequency of 200 Hz measured at a temperature of 0, 20 and 40° C.

As used herein, unless otherwise expressly specified, all numbers such as those expressing values, ranges, amounts or percentages may be read as if prefaced by the word “about”, even if the term does not expressly appear. Any numerical range recited herein is intended to include all sub-ranges subsumed therein. Plural encompasses singular and vice versa. Also, as used herein, the term “polymer” is meant to refer to prepolymers, oligomers and both homopolymers and copolymers; the prefix “poly” refers to two or more.

### DETAILED DESCRIPTION OF THE INVENTION

The aqueous dispersion of polymeric microparticles suitable for use in the present invention, may be thermoplastic and may include functionality that permits crosslinking with suitable crosslinking agents such as but not limited to aminoplasts or polyisocyanates. The polymeric microparticles are essentially hydrophobic, and dispersible in water. The term “dispersion” and like terms mean the polymeric microparticles are capable of being distributed throughout the water as finely divided particles such as latex. See Hawley's Condensed Chemical Dictionary, (12^{th} edition, 1993) at page 435.

Aqueous dispersions of polymeric microparticles and their methods of preparation are disclosed in U.S. Pat. No. 6,531,541 at col. 3, line 59, to col. 11, line 11, the portions of which are hereby incorporated by reference.

Generally, the polymeric microparticles are present in the coating composition of the present invention in an amount of from 4 to 70, or 5 to 40 percent by weight based on total weight of the composition. Water is present in the composition in an amount of from 5 to 40, or 15 to 30 percent by weight based on total weight of the coating composition. The coating composition of the present invention comprises a filler. While the inventors do not wish to be bound by any theory, it is believed that the filler is responsible for the sound dampening properties of the coating. The filler is present in the coating composition of the present invention in an amount of from 20 to 90 percent by weight, or 40 to 70 percent by weight based on total weight of the composition.

In an embodiment, the filler may comprise calcium magnesium carbonate, barium sulfate, a mineral fiber such as calcium metasilicate and mixtures thereof. In a further embodiment, the filler may optionally include an organically modified clay (organoclay) such as those commercially available under the trademark BENTONE.

Not intending to be bound by any theory, it is believed that calcium magnesium carbonate provides sound dampening properties and may be present in the coating composition of the present invention in an amount of from 5 to 90 percent by weight based on total weight of the coating composition.

Not intending to be bound by any theory, it is believed that barium sulfate improves coating appearance and may be present in the coating composition of the present invention in an amount of from 5 to 50 percent by weight based on total weight of the coating composition.

Not intending to be bound by any theory, it is believed that mineral fiber provides sound dampening properties and may be present in the coating composition of the present invention in an amount of from 10 to 70 percent by weight based on total weight of the coating composition.

Organoclays may be present in the coating composition of the present invention in an amount of from 0.05 to 2 percent by weight, based on total weight of the coating composition.

The plasticizer for use in the coating composition of the present invention comprises at least two different plasticizers. Non-limiting examples of suitable plasticizers may include adipates, benzoates, glutarates, phthalates, butyrates, phosphates, polyesters, sebacates, glycols such as but not limited to alkylene glycol containing from two to six carbon atoms, sulfonamides and mixtures thereof. In an embodiment, the plasticizer comprises a mixture selected from phthalates, butyrates and glycols. In a further embodiment, the plasticizer is a mixture of benzyl phthalate, 2,2,4-trimethyl-1,3-pentanediol diisobutyrate and propylene glycol. The amount of plasticizer present in the coating composition may be from greater than 0.1 to less than 20 percent by weight based on total weight of the coating composition. Amounts of 0.1 percent or less by weight do not result in good appearance, whereas amounts of 20 percent or more by weight adversely affect appearance and sound dampening properties of the coating.

The coating composition of the present invention may include a variety of other optional ingredients and/or additives. The use of these ingredients and/or additives may be dependent on the particular application of the composition. Non-limiting examples of such ingredients and/or additives may include but are not limited to dyes or pigments such as carbon black or graphite, reinforcements, organic rheology agents, surfactants, corrosion inhibitors, organic solvents, foam control agents, expandable microspheres, antioxidants, and mixtures thereof. These optional ingredients and additives, may be present individually in amounts of from 0 to 20 percent by weight based on total weight of the coating composition.

In another embodiment of the present invention plastisols such as polyvinyl chloride may be present in the coating composition in an amount of from 2 to 10 percent by weight based on total weight of the coating composition. Not intending to be bound by any theory, it is believed that plastisols may improve sound dampening properties.

The viscosity of the coating composition of the present invention may depend on its use or application as well as type of equipment employed, desired film thickness and sag resistance. In alternate embodiments, the viscosity of the coating composition of the present invention may be greater than 1000, or from 1000 to 1,000,000 centipoise (“cp”) measured at 2 RPM with a #7 spindle Brookfield measurement. In a further embodiment, a sprayable composition may have a viscosity less than 100,000 cp at 20 RPM reading on the Brookfield viscometer at ambient temperature (about 25° C.).

The coating composition of the present invention may be prepared using various conventional techniques and equipment known in the art. In an embodiment, the polymeric microparticle dispersion may be mixed with the filler and other components of the coating composition in a high-energy vacuum mixer such as Dual Disperser Model HHL-2-1000 commercially available from Hockmeyer.

The coating composition of the present invention may be applied to the surface of a substrate using a wide variety of conventional techniques and equipment known in the art, Non-limiting examples may include spraying, extrusion, or by hand with a blade. Suitable substrates for use in the present invention are numerous and varied. Non-limiting examples may include but are not limited to those formed from metal, polymers such as thermoset materials and thermoplastic materials, and combinations of metal and polymeric substrates. Suitable metal substrates that can be coated according to the present invention include ferrous metals such as iron, steel, and alloys thereof non-ferrous metals such as aluminum, zinc, magnesium and alloys thereof, and combinations thereof. In non-limiting embodiments, the substrate may be formed from cold rolled steel, electrogalvanized steel such as hot dip electrogalvanized steel or electrogalvanized iron-zinc steel, aluminum or magnesium. The substrate to be coated may be bare, pretreated or prepainted (for example by electrocoating) prior to application of the sound dampening composition.

Useful thermoset materials may include polyesters, epoxides, phenolics, polyurethanes such as reaction injected molding urethane (RIM) thermoset materials and mixtures thereof. Useful thermoplastic materials include thermoplastic polyolefins such as polyethylene and polypropylene, polyamides such as nylon, thermoplastic polyurethanes, thermoplastic polyesters, acrylic polymers, vinyl polymers, polycarbonates, acrylonitrile-butadiene-styrene (ABS) copolymers, EPDM rubber, copolymers and mixtures thereof.

The thickness of the applied coating in the present invention is not believed to be critical and may be adjusted such that the final dried coating is effective in suppressing noise and vibration transmission to a desired extent. In alternate embodiments, the dried coating may have a thickness of at least 1000 microns thick, or from 2000 to 5000 microns. After applying the aqueous coating composition of the present invention to the substrate surface, it may first be permitted to dry partially at ambient or slightly elevated temperature, followed by heating of the coated substrate. Drying of the coating can be performed by any suitable method such as air drying, oven drying or induction heating. When heat is applied, drying temperatures will typically be in the range of from about 110° C. to 175° C.

In general, the coating composition of the invention finds application in the quarter panels, the roof, the door, the interior, the floor pan, and the wheel house of motor vehicles. In other applications, the coating composition can be used in a suitable position on the inside or outside of a structure, e.g., a vehicle or an aircraft or a building, to provide maximum sound damping performance.

### EXAMPLES

The following examples are intended to illustrate the invention, and should not be construed as limiting the invention in any way.

The Examples show the preparation of various aqueous sound dampening compositions. Example 1 was a control with no plasticizer in the composition. Examples 2, 3, 5 and 6 were of the invention containing at least two different plasticizers in the composition. Examples 4, 7, 8 and 9 were comparative Examples. Example 7 contained only one plasticizer, Example 4 contained three different plasticizers, but at a low total plasticizer content. Examples 8 and 9 contained three different plasticizers but at a high total plasticizer content. Table 1 below summarizes the various formulations.

The ingredients of each of the compositions shown in Table 1 below were mixed at low agitation in a pint-sized container using an air-driven motor. The ingredients were added to the container in the order shown in Table 1, and the mixing speed was increased to maintain a vortex throughout the addition. Each sample was placed in a vacuum chamber equipped with an agitator and a vacuum of at least 700 mm Hg to the agitated sample. The sample was removed when foaming subsided (35 minutes).

TABLE 1
Aqueous Sound Deadener Compositions

| Components | EX-1 | EX-2 | EX-3 | EX-4 | EX-5 | EX-6 | EX-7 | EX-8 | EX-9 |
|---|---|---|---|---|---|---|---|---|---|
| Aqueous Resinous | 62.7 | 62.7 | 62.7 | 62.7 | 62.7 | 62.7 | 62.7 | 62.7 | 62.7 |
| Dispersion¹ | | | | | | | | | |
| PM 210² | 1.1 | 1.1 | 1.1 | 1.1 | 1.1 | 1.1 | 1.1 | 1.1 | 1.1 |
| Aquablack 245³ | 0.2 | 0.2 | 0.2 | 0.2 | 0.2 | 0.2 | 0.2 | 0.2 | 0.2 |
| Foamaster 111⁴ | 0.5 | 0.5 | 0.5 | 0.5 | 0.5 | 0.5 | 0.5 | 0.5 | 0.5 |
| Dolocron 4512⁵ | 140 | 140 | 140 | 140 | 140 | 30.5 | 140 | 140 | 140 |
| Vansil W-10⁶ | — | — | — | — | — | 79.5 | — | — | — |
| Sparwite W-10⁷ | — | — | — | — | — | 30.5 | — | — | — |
| Santicizer 278⁸ | — | 3.9 | | 0.1 | 3.9 | 3.9 | 3.9 | 13.5 | 31 |
| Propylene Glycol⁹ | — | 2.44 | 2.44 | 0.1 | 2.44 | 2.44 | — | 2.5 | 2.5 |
| TXIB¹⁰ | — | 2.44 | 2.44 | 0.1 | 2.44 | 2.44 | — | 8 | 18.5 |
| Acrysol RM-8¹¹ | — | 0.5 | — | — | — | — | — | — | — |
| PM 495¹² | 5 | — | 6 | 4.5 | 6 | 6 | 6 | 2 | 2 |
| Total | 209.5 | 213.78 | 215.38 | 209.3 | 219.28 | 219.78 | 213.4 | 230.5 | 258.5 |

¹Aqueous resinous dispersion of polymeric microparticles prepared as generally described in U.S. Pat. No. 6,531,541. Resin solids content of about 40 percent.
²PM 210: Water dispersion of 33% sodium salt of naphthalenesulfonic acid.
³Aquablack 245: Water dispersion of carbon black commercially available from Borden Chemical Company.
⁴Foamaster 111: Hydrocarbon defoamer commercially available from Cognis Canada.
⁵Dolocron 4512: Dolomite calcium magnesium carbonate commercially available from Specialty Minerals.
⁶Vansil W-10: Calcium metasilicate from R.T. Vanderbilt Company.
⁷Sparwite W-10: Barium sulfate commercially available from Mountain Minerals Company.
⁸Santicizer 278: 2,2,4-trimethyl-1,3-pentanediol monoisobutyrate ester commercially available from Monsanto Chemical Company.
⁹Propylene Glycol: Commercially available from Dow Chemical.
¹⁰TXIB: 2,2-dimethyl-1-(methylethyl)-1,3-propanediyl bis(2-methylpropanoate) commercially available from Eastman Chemical Company.
¹¹Acrysol RM-8: Rheology modifier water-soluble polyurethane commercially available from Rohm & Haas.
¹²PM 495: Rheology modifier water dispersion of 10% Bentone EW organoclay.

Draw downs of 3-4 inch long samples using a 3-inch wide 120-mil thick coating template were prepared on test panels coated with ED-6060 electrocoat which is commercially available from PPG Industries, Inc. of Pittsburgh, Pa. Each draw down was air dried at ambient temperature (25° C.).

Mudoracking was evaluated on a separate set of panels. The mudcracking determination was a visual determination based upon number, width and length of cracks. The coating on each panel was cured for one hour at ambient temperature (25° C.) and then for 7 minutes at 110° C., followed by a 30-minute exposure to ambient temperature and finally a 15-minute exposure to 175° C.

The sound damping of each coating was measured using the Oberst ASTM Test Method E756-93 (“Standard Test Method for Measuring Vibration-Damping Properties of Materials”), Sections 3 and 10. The principal measure of sound deadening in this test is loss factor, the ratio of loss modulus to storage modulus of the material. Oberst values typically range from 0.001 for uncoated steel (thickness 30 mils) (if the steel panel is struck, one would hear a “clang”) to 0.01 (“bong”) to 0.1 (“bunk”) to 0.5 (“thud”) for increasingly efficient coatings. The Oberst test measures the sound loss factor of the coating-substrate composite.

Each test sample was applied to an Oberst Bar, which is a metal bar formed from special oil-hardening ground flat stock, AISI/SAE GRD 0-1, 1/32 inch (0.8 mm) thick, ½ inch (12.7 mm) wide from McMaster-Carr, part number 89705-K121 and cured as described above. The weight of each cured coating was 9.0±0.12 grams. The Oberst loss factor values were normalized to 9.0 grams for comparison. Composite loss factors were compared at 200 Hz at temperatures of 0, 20 and 40° C. The results are reported in Table 2 below.

TABLE 2

| | | | | | | | | |
|---|---|---|---|---|---|---|---|---|
| EX-1 | EX-2 | EX-3 | EX-4 | EX-5 | EX-6 | EX-7 | EX-8 | EX-9 |

Coating appearance after drying

| | | | | | | | | | |
|---|---|---|---|---|---|---|---|---|---|
| Mudcracking | severe | none | slight | slight | none | slight | moderate | slight | severe |
| | | | | | | | | | cratering |

Oberst Sound Damping Test

| | | | | | | | | | |
|---|---|---|---|---|---|---|---|---|---|
| Coating | 8.99 | 8.94 | 8.99 | 9.00 | 8.94 | 8.88 | 8.98 | 9.02 | 8.97 |
| Weight (g) | | | | | | | | | |

Oberst Loss Factor @ 200 Hz
Normalized to 9 g weight

| | | | | | | | | | |
|---|---|---|---|---|---|---|---|---|---|
| 0° C. | 0.025 | 0.220 | 0.087 | 0.023 | 0.198 | 0.159 | 0.089 | 0.095 | 0.011 |
| 20° C. | 0.104 | 0.329 | 0.227 | 0.110 | 0.233 | 0.252 | 0.246 | 0.017 | 0.003 |
| 40° C. | 0.264 | 0.122 | 0.155 | 0.261 | 0.090 | 0.112 | 0.119 | 0.011 | 0.007 |

The experimental results summarized in Table 2 above show that the composition of the invention (Examples 2, 3, 5 and 6) have in general better appearance and better sound dampening properties than the control (Example 1) and the comparative Examples (Examples 4, 7, 8 and 9).

Whereas particular embodiments of this invention have been described above for purposes of illustration, it will be evident to those skilled in the art that numerous variations of the details of the present invention may be made without departing from the invention as defined in the appended claims.

What is claimed is:

1. An aqueous coating composition exhibiting sound dampening properties, the coating composition comprising an aqueous dispersion of polymeric microparticles, a filler and a plasticizer, wherein the plasticizer comprises at least two different plasticizers and the plasticizer is present in an amount of from greater than 0.1 to less than 20 percent by weight based on total weight of the coating composition.

2. The coating composition of claim 1 in which the plasticizers are selected from phthalates, isobutyrates, sulfonamides and glycols.

3. The coating composition of claim 1 in which the coating composition comprises an isobutyrate and a glycol.

4. The coating composition of claim 3 in which the isobutyrate is 2,2,4-trimethyl-1,3-pentanediol diisobutyrate and the glycol is propylene glycol.

5. The coating composition of claim 2 in which the plasticizers are selected from an isobutyrate, a glycol and a phthalate.

6. The coating composition of claim 5 in which the plasticizer is selected from benzyl phthalate, 2,2,4-trimethyl-1,3-pentanediol diisobutyrate and propylene glycol.

7. The coating composition of claim 1 in which the filler contains calcium metasilicate.

8. The coating composition of claim 1 in which the filler contains barium sulfate.

9. The coating composition of claim 8 in which the barium sulfate is present in amounts of 5 to 50 percent by weight based on total weight of the composition.

10. The coating composition of claim 1, which contains a polyvinyl chloride plastisol.

11. The coating composition of claim 1, which contains an organo-modified clay.

12. In an aqueous coating composition exhibiting sound dampening properties as measured by a composite loss factor of at least 0.01 at a frequency of 200 Hz measured at a temperature of 0, 20 and 40° C., the coating composition comprising an aqueous dispersion of polymeric microparticles, a filler and a plasticizer, wherein the plasticizer comprises at least two different plasticizers and the plasticizer is present in an amount of from greater than 0.1 to less than 20 percent by weight based on total weight of the coating composition.

13. The coating composition of claim 12 in which the plasticizers are selected from isobutyrates, phthalates, glycols and sulfonamides.

14. The coating composition of claim 12 in which the plasticizers are 2,2,4-trimethyl-1,3-pentanediol diisobutyrate, benzyl phthalate and propylene glycol.

15. The coating composition of claim 12 in which the barium sulfate is present in the composition in amounts of 5 to 50 percent by weight based on total weight of the composition.

16. The coating composition of claim 1, which contains expandable microspheres.

17. In an aqueous coating composition exhibiting sound dampening properties as measured by a composite loss factor of at least 0.01 at a frequency of 200 Hz measured at a temperature of 0, 20 and 40° C., the coating composition comprising an aqueous dispersion of polymeric microparticies, a filler and a plasticizer, wherein the plasticizer comprises at least two different plasticizers and the plasticizer is present in an amount of from greater than 0.1 to less than 20 percent by weight based on total weight of the coating composition and the filler contains barium sulfate.
